(19) United States
(12) Patent Application Publication
(10) Pub. No.: US 2015/0011258 A1
(43) Pub. Date: Jan. 8, 2015

(54) IMAGING COVER FOR A MOBILE COMMUNICATION DEVICE

(71) Applicant: Research In Motion Limited, Waterloo (CA)

(72) Inventors: Weimin RANG, Stouffville (CA); Peter MANKOWSKI, Waterloo (CA); Xiaowei WU, Waterloo (CA); Yaran NAN, Kitchener (CA)

(73) Assignee: Research In Motion Limited, Waterloo (CA)

(21) Appl. No.: 13/936,797

(22) Filed: Jul. 8, 2013

(51) Int. Cl. H04M 1/02

(52) U.S. Cl. CPC H04M 1/0254
USPC 455/556.1

(57) ABSTRACT

A method and apparatus for obtaining an image at a mobile communication device is disclosed. The apparatus includes a cover for the mobile communication device. The cover includes an imaging device and a communication module configured to wirelessly communicate content from the imaging device to the mobile communication device. The cover includes a solid member and a flexible member configured to bend relative to the solid member to support the cover at a support structure. The cover may be placed at a location remote from the mobile communication device, obtain the image at the remote location and communicate the image to the mobile communication device using a wireless communication link.

### BACKGROUND

Thermal imaging devices are often used in military applications or law enforcement and are often large and bulky. However, miniaturization of components has made it possible to make smaller and more light-weight thermal imaging devices, thereby allowing consideration of new uses and applications.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 shows an illustrative mobile cellular communication device that may be suitable for use in one embodiment of the disclosure;

FIG. 2 depicts a block diagram of an exemplary electronic device in accordance with an embodiment of the disclosure;

FIG. 3 shows a front view of the mobile cellular communication device of FIG. 1 with a cover attached;

FIG. 4 shows a side view of the mobile cellular communication device with cover attached;

FIG. 5 shows a side view of an illustrative track system for slidably engaging and disengaging the cover to and from the mobile cellular communication device;

FIG. 6 shows a back side perspective view of the mobile cellular communication device and cover;

FIG. 7 is a diagram showing a schematic of electronic components of the cover;

FIG. 8 illustrates a method of obtaining an image at the mobile cellular communication device when the cover is disengaged from the mobile cellular communication device; and

FIGS. 9-11 show various configurations of the cover for supporting the cover at a support structure.

### DETAILED DESCRIPTION

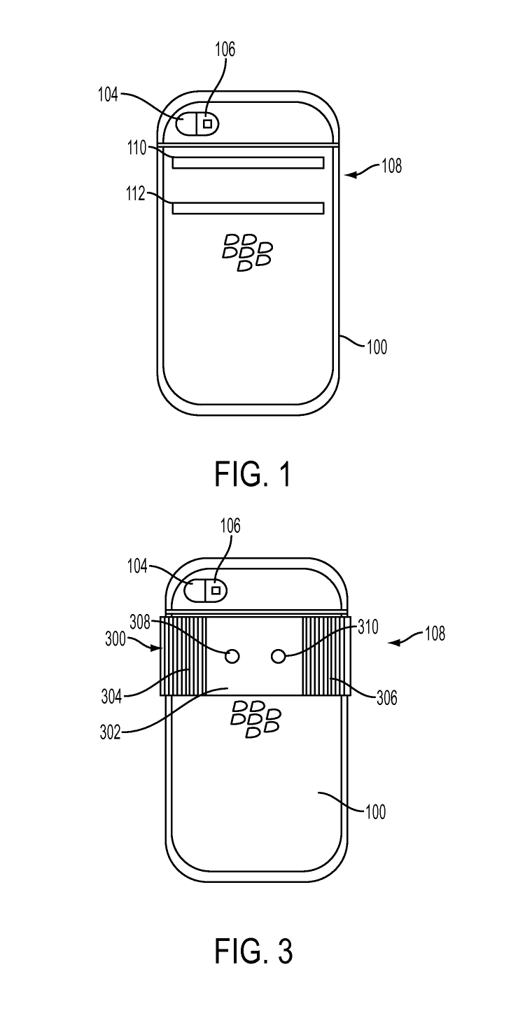

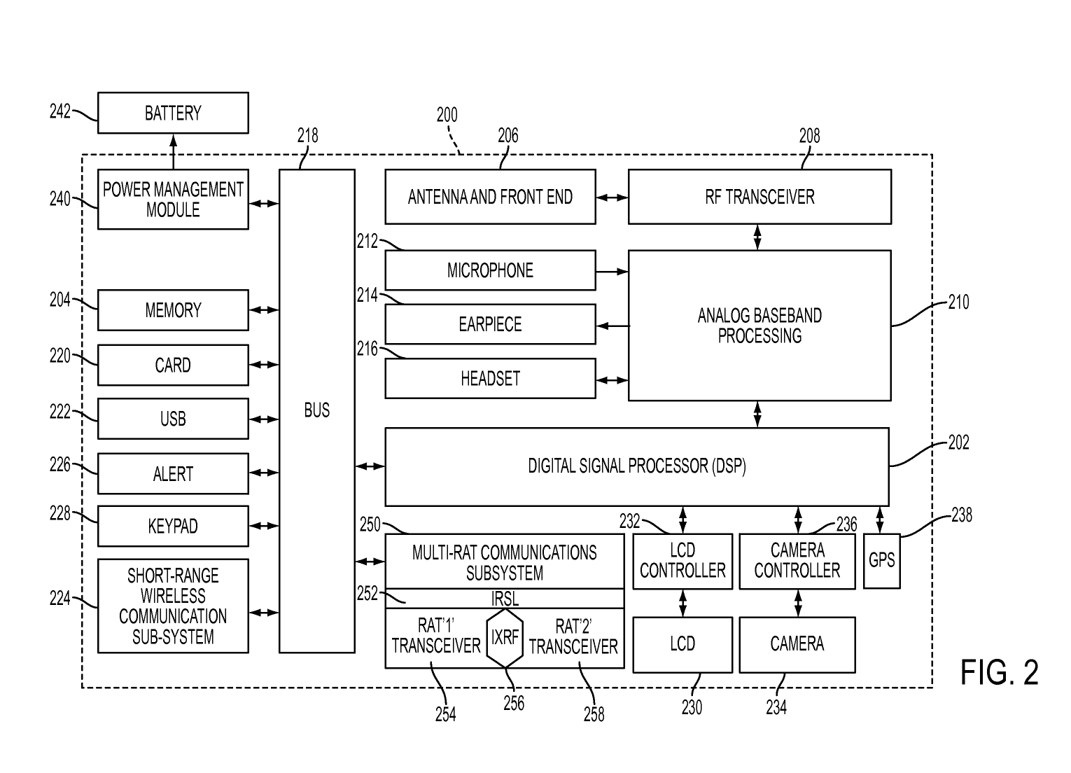

FIG. 1 shows an illustrative mobile cellular communication device 100 that may be suitable for use in one embodiment. The mobile cellular communication device 100 is referred to herein as a “smartphone” but may be any suitable communication device such as smartphone, a cellular phone, a tablet, etc. The smartphone 100 includes, among many other features, a camera 104 and a flash 106 that may be used with the camera 104 to take pictures. The smartphone 100 may be capable of communication over several types of wireless communication links, as discussed below with respect to FIG. 2. The smartphone 100 may also include a Universal Serial Bus (USB) port or socket 108 that may be used to establish communication between the smartphone 100 and another electronic device. The smartphone 100 further includes a set of tracks 110 and 112 that may be used to couple, attach or engage an object to the smartphone 100. Details of tracks 110 and 112 are discussed further below with respect to FIG. 5.

FIG. 2 depicts a block diagram of an exemplary electronic device 200, e.g., smartphone 100 of FIG. 1, or another computing device in accordance with an embodiment of the disclosure. While various components of the device 200 are depicted, various embodiments of the device 200 may include a subset of the listed components or additional components not listed. As shown in FIG. 2, the device 200 includes a processor 202 (to process the images, for example) and a memory 204 (to store instructions to be executed to process the images). As shown, the device 200 may further include an antenna and front end unit 206, a radio frequency (RF) transceiver 208, an analog baseband processing unit 210, a microphone 212, an earpiece speaker 214, a headset port 216, a bus 218, such as a system bus or an input/output (I/O) interface bus, a removable memory card 220, a universal serial bus (USB) port 222, a short range wireless communication sub-system 224, an alert 226, a keypad 228, a display 230, which may include a touch sensitive surface, a display controller 232, a charge-coupled device (CCD) camera 234, a camera controller 236, and a global positioning system (GPS) sensor 238, and a power management module 240 operably coupled to a power storage unit, such as a battery 242. In various embodiments, the device 200 may include another kind of display that does not provide a touch sensitive screen. In one embodiment, the DSP 202 communicates directly with the memory 204 without passing through the input/output interface (“Bus”) 218.

In various embodiments, the DSP 202 or some other form of controller or central processing unit (CPU) operates to control the various components of the device 200 in accordance with embedded software or firmware stored in memory 204 or stored in memory contained within the DSP 202 itself. In addition to the embedded software or firmware, the DSP 202 may execute other applications stored in the memory 204 or made available via information media such as portable data storage media like the removable memory card 220 or via wired or wireless network communications. The application software may comprise a compiled set of machine-readable instructions that configure the DSP 202 to provide the desired functionality, or the application software may be high-level software instructions to be processed by an interpreter or compiler to indirectly configure the DSP 202.

The antenna and front end unit 206 may be provided to convert between wireless signals and electrical signals, enabling the device 200 to send and receive information from a cellular network or some other available wireless communications network or from a peer device 200. In an embodiment, the antenna and front end unit 206 may include multiple antennas. Likewise, the antenna and front-end unit 206 may include antenna tuning or impedance matching components, RF power amplifiers, or low noise amplifiers.

Note that in this diagram the radio access technology (RAT) RAT1 and RAT2 transceivers 254, 258, the IXRF 256, the IRSL 252 and Multi-RAT subsystem 250 are operably coupled to the RF transceiver 208 and analog baseband processing unit 210 and then also coupled to the antenna and front end 206 via the RF transceiver 208. As there may be multiple RAT transceivers, there will typically be multiple antennas or front ends 206 or RF transceivers 208, one for each RAT or band of operation.

The analog baseband processing unit 210 may provide various analog processing of inputs and outputs for the RF transceivers 208 and the speech interfaces (212, 214, 216). For example, the analog baseband processing unit 210 receives inputs from the microphone 212 and the headset 216 and provides outputs to the earpiece 214 and the headset 216. To that end, the analog baseband processing unit 210 may have ports for connecting to the built-in microphone 212 and the earpiece speaker 214 that enable the device 200 to be used as a cell phone. The analog baseband processing unit 210 may further include a port for connecting to a headset or other hands-free microphone and speaker configuration. The analog baseband processing unit 210 may provide digital-to-analog conversion in one signal direction and analog-to-digital conversion in the opposing signal direction. In various embodiments, at least some of the functionality of the analog baseband processing unit 210 may be provided by digital processing components, for example by the DSP 202 or by other central processing units.

The DSP 202 may perform modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions associated with wireless communications. In an embodiment, for example in a code division multiple access (CDMA) technology application, for a transmitter function the DSP 202 may perform modulation, coding, interleaving, and spreading, and for a receiver function the DSP 202 may perform despreading, deinterleaving, decoding, and demodulation. In another embodiment, for example in an orthogonal frequency division multiplex access (OFDMA) technology application, for the transmitter function the DSP 202 may perform modulation, coding, interleaving, inverse fast Fourier transforming, and cyclic prefix appending, and for a receiver function the DSP 202 may perform cyclic prefix removal, fast Fourier transforming, deinterleaving, decoding, and demodulation. In other wireless technology applications, yet other signal processing functions and combinations of signal processing functions may be performed by the DSP 202.

The DSP 202 may communicate with a wireless network via the analog baseband processing unit 210. In some embodiments, the communication may provide Internet connectivity, enabling a user to gain access to content on the Internet and to send and receive e-mail or text messages. The input/output interface (“Bus”) 218 interconnects the DSP 202 and various memories and interfaces. The memory 204 and the removable memory card 220 may provide software and data to configure the operation of the DSP 202. Among the interfaces may be the USB interface 222 and the short range wireless communication sub-system 224. The USB interface 222 may be used to charge the device 200 and may also enable the device 200 to function as a peripheral device to exchange information with a personal computer or other computer system. The short range wireless communication sub-system 224 may include an infrared port, a Bluetooth™ interface, an IEEE 802.11 compliant wireless interface, or any other short range wireless communication sub-system, which may enable the device 200 to communicate wirelessly with other nearby client nodes and access nodes. The short-range wireless communication sub-system 224 may also include suitable RF Transceiver, Antenna and Front End subsystems.

The keypad 228 couples to the DSP 202 via the I/O interface (“Bus”) 218 to provide one mechanism for the user to make selections, enter information, and otherwise provide input to the device 200. The keyboard 228 may be a full or reduced alphanumeric keyboard such as QWERTY, DVORAK, AZERTY and sequential types, or a traditional numeric keypad with alphabet letters associated with a telephone keypad. The input keys may likewise include a track wheel, track pad, an exit or escape key, a trackball, and other navigational or functional keys, which may be inwardly depressed to provide further input function. Another input mechanism may be the LCD 230, which may include touch screen capability and also display text and/or graphics to the user. The LCD controller 232 couples the DSP 202 to the LCD 230.

The CCD camera 234, if equipped, enables the device 200 to make digital pictures. The DSP 202 communicates with the CCD camera 234 via the camera controller 236. In another embodiment, a camera operating according to a technology other than Charge Coupled Device cameras may be employed. The GPS sensor 238 is coupled to the DSP 202 to decode global positioning system signals or other navigational signals, thereby enabling the device 200 to determine its position. The GPS sensor 238 may be coupled to an antenna and front end (not shown) suitable for its band of operation. Various other peripherals may also be included to provide additional functions, such as radio and television reception.

In various embodiments, the device 200 comprises a first Radio Access Technology (RAT) transceiver 254 and a second RAT transceiver 258. As shown in FIG. 2, the RAT transceivers ‘1’ 254 and ‘2’ 258 are in turn coupled to a multi-RAT communications subsystem 250 by an Inter-RAT Supervisory Layer Module 252. In turn, the multi-RAT communications subsystem 250 is operably coupled to the Bus 218. Optionally, the respective radio protocol layers of the first Radio Access Technology (RAT) transceiver 254 and the second RAT transceiver 258 are operably coupled to one another through an Inter-RAT eXchange Function (IRXF) Module 256.

In various embodiments, a network node acting as a server comprises a first communication link corresponding to data to/from the first RAT and a second communication link corresponding to data to/from the second RAT.

Turning now to FIG. 3, FIG. 3 shows the smartphone 100 of FIG. 1 with a cover 300 attached. The cover 300 includes a solid member 302 and at least one flexible member, shown in FIG. 3 as flexible members 304 and 306, that is attached to the solid member 302. In one embodiment, the solid member 302 is a middle section of the cover 300 and the flexible members 304 and 306 are attached on opposite ends of the solid member 302. However, the flexible members 304 and 306 may be attached to the solid member 302 in any suitable configuration. In various configurations, such as illustrated below in FIGS. 9-11, the flexible members 304 and 306 may be molded into a shape that is suitable for supporting the cover 300 at a support structure such as a table, pole, etc. The flexible members 304 and 306 may be made of a material that may be molded, flexibly deformed or bent into a selected shape given a sufficient force, wherein the force may be easily applied by a human. The flexible member 304 and 306 may then maintain the molded shape to support the cover 300 or to support an assembly of the cover 300 and the smartphone 100.

The cover 300 further includes an imaging device for taking an image or visual content. The imaging device may be one or both of an optical camera 308 for taking images and/or video content in an optical region of the electromagnetic spectrum and a thermal imaging device or thermal camera 310 for taking thermal images and/or thermal video content in an infrared region of the electromagnetic spectrum. In one embodiment, the optical camera 308 and the thermal camera 310 are located at the solid member 302 of cover 300. Although shown as two separate lenses, the optical camera 308 and the thermal camera 310 may be kept under a single protective dome (not shown).

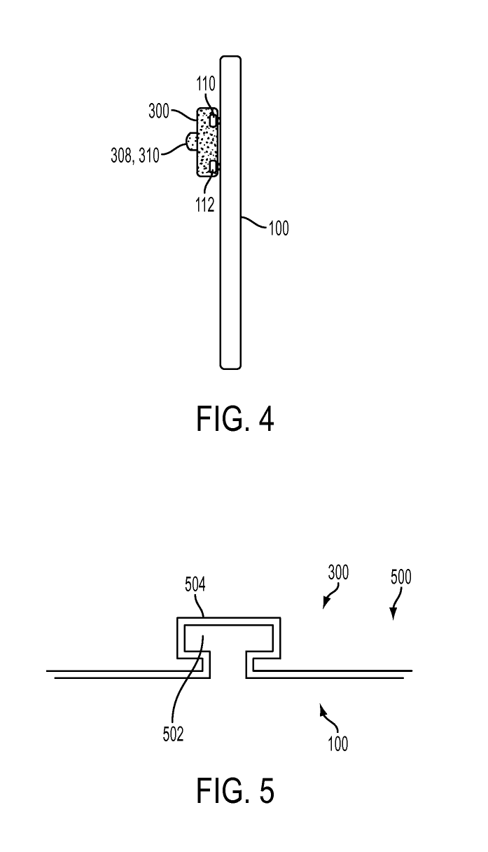

FIG. 4 shows a side view of the smartphone 100 with cover 300 attached. Optical camera 308 and thermal camera 310 are extended from the surface of the cover 300. The cover 300 is attached to the smartphone using tracks 110 and 112. In one embodiment, the tracks 110 and 112 are features that are extended from the smartphone 100 (as shown in FIG. 5). Complementary grooves to the tracks 110 and 112 may be formed in the cover 300 in order to facilitate attaching the cover 300 to the smartphone 100. In one embodiment, the cover 300 slides along tracks 110 and 112 into an engaged position with the smartphone 100.

FIG. 5 shows a side view of an illustrative track system 500 for slidably engaging and disengaging the cover 300 to and from the smartphone 100. As illustrated in FIG. 5, the track 502 may be a T-shaped feature extending from the smartphone 100 and the groove 504 may be a T-shaped groove formed in the cover 300. The shape of the groove 504 may be complementary to the shape of track 502. In general, the groove 504 is formed in the solid member 302 of the cover 300. With respect to the side view of FIG. 5, the cover 300 slides into and out of the page along the track 502 and groove 504. The particular shape of the track 502 and the groove 504 is not a critical aspect of the invention. Additionally, in alternate embodiments, the track 502 may be a feature extending from the cover 500 and the groove 504 may be formed in the smartphone 100.

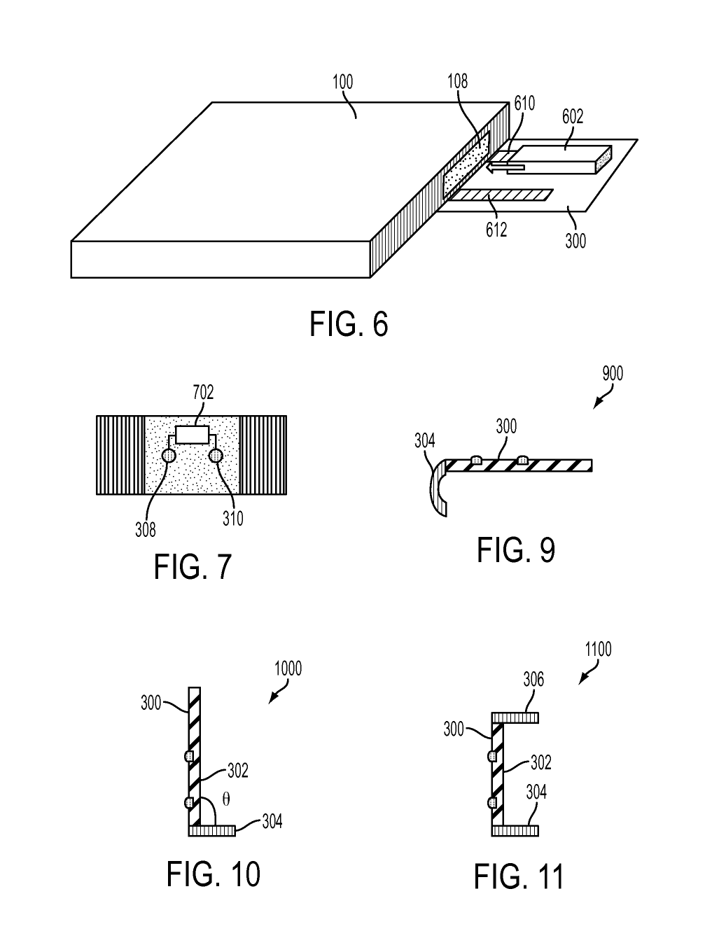

FIG. 6 shows a back side perspective view of the smartphone 100 and cover 300. The cover 300 includes complementary sliding features 610 and 612 that are complementary to features 110 and 112 of the smartphone 100 for sliding the cover 300 relative to the smartphone 100 for engagement of the cover 300 with the smartphone 100. In the illustrative embodiment of FIG. 6, features 110 and 112 are extended tracks and features 610 and 612 are complementary grooves. However, which of features 110, 112 and features 610, 612 are used as the tracks and which are used as the grooves is not considered a limitation of the invention. The cover 300 includes a communication plug such as USB plug 602 that is electrically coupled to the optical camera (308, FIG. 3) and/or the thermal camera (310, FIG. 3). The USB plug 602 is positioned on a side of cover 300 that is opposite the optical camera (308, FIG. 3) and the thermal camera (310, FIG. 3) so that when the cover 300 is in a position suitable for sliding into engagement with smartphone 100, the USB plug 602 is in alignment with the communication socket, USB socket, 108 of the smartphone 100. Sliding the cover 300 into secured engagement with the smartphone 100 causes the USB plug 602 to be inserted into the USB socket 108, thereby establishing a wired communication between the cover 300 and the smartphone 100. Therefore, when the cover 300 is engaged to the smartphone 100, image content, such as optical and/or thermal images, may be taken by an operator of the smartphone 100 via the optical camera 308 and/or the thermal camera 310. The image content may be sent to the smartphone 100 via the established USB connection.

FIG. 7 is a diagram showing a schematic of electronic components of the cover 300. The cover 300 includes a communication module 702 configured to establish a wireless communication link between the cover 300 and the smartphone 100 when the cover 300 is not attached to or engaged with the smartphone 100. The communication module 702 is coupled to the optical camera 308 and the thermal imaging camera 310 and may receive content (e.g., optical imaging content, thermal imaging content) from these cameras. When the cover 300 is removed from the smartphone 100 (i.e., the USB connection is disengaged), the communication module 702 may send content from the optical camera 308 and the thermal camera 310 to the smartphone 100 via the wireless communication link. In an illustrative embodiment, the wireless communication link is a Bluetooth™ communication link. However, any suitable short-range wireless communication link may be used between the cover 300 and the smartphone 100.

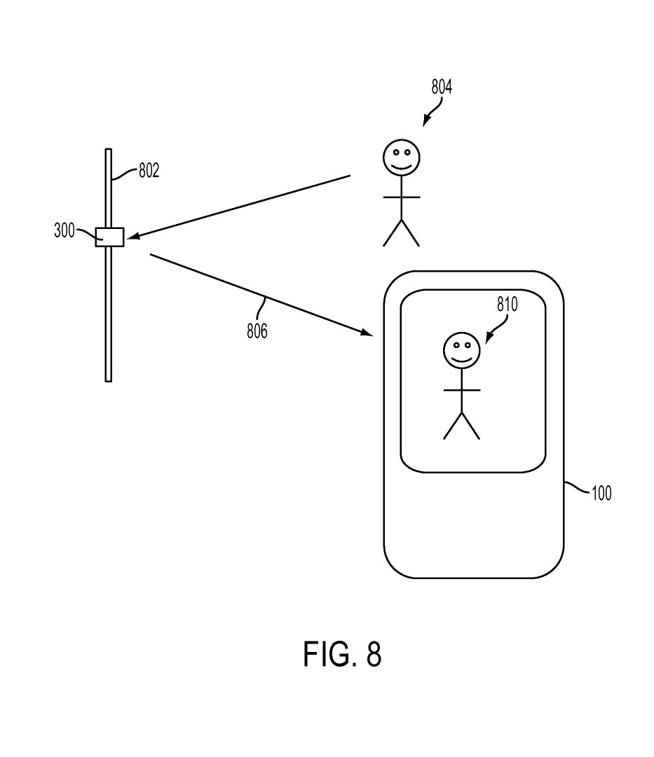

FIG. 8 illustrates a method of obtaining an image at the smartphone 100 when the cover 300 is disengaged from the smartphone 100. The cover 300 is disposed at a location remote from the smartphone 100. In FIG. 8, the cover 300 is attached to a support structure such as pole 802. The optical and/or thermal camera of the cover 300 is used to obtain an image 810 (either optical or thermal) of an object of interest 804 at the cover 300. The communication module (702, FIG. 7) of the cover 300 then sends the image content from the cover 300 at the remote location to the smartphone 100. The cover 300 may thus be useful in a law enforcement situation where the cover 300 may be disposed at a location that is considered dangerous while a law enforcement officer may receive thermal and optical images 810 from the cover 300 at her smartphone 100 in a relatively safe location via the wireless communication link 806. The law enforcement officer may also be able to communicate with other law enforcement officers using the smartphone 100 as well as to communicate the image content obtained from the remote location to other law enforcement officers. In various aspects, disposing the cover 300 at a given location may be realized using the one or more of the flexible members 304 and 306 of the cover 300, as discussed below with respect to FIG. 9-11.

FIG. 9 shows a configuration 900 in which one of the flexible members (for example, flexible member 304) has been molded into a hooked shape so that a side view of the cover 300 takes on the shape of a “J.” The hooked shape configuration 900 may be used, for example, to hang the cover 300 from a support structure, such as a surface edge, a curtain rod, a hook, etc. FIG. 10 shows an alternate configuration 1000 in which one of the flexible members (for example, flexible member 304) has been bent into a straight edge that is at an angle θ to the solid member 302 of the cover 300. In this “L”-shaped configuration 1000, the bent flexible member 304 may be used to support the cover 300 on a substantially flat surface, such as a table top, floor, etc. The angle θ between the bent flexible member 304 and solid member 302 may be a perpendicular angle as shown in FIG. 10 or may be any other angle suitable for providing support to cover 300. FIG. 11 shows an alternate configuration 1100 in which both flexible members 304 and 306 are bent at an angle relative to the solid member 302 of the cover 300. Bending both flexible members 304 and 306 may be useful to wrap the cover 300 around a suitable supporting structure, such as a rod or pole, etc. Additionally, the cover may be wrapped around a person's arm and worn as a bracelet. The configurations shown in FIGS. 9-11 are only illustrative examples and other molded configurations of the cover 300 may be used to support the cover 300 on support structures that have shapes that have not been specified herein.

Therefore, in one embodiment an apparatus includes: a solid member configured to engage with a mobile cellular communication device; an imaging device disposed at the solid member configured to obtain a thermal image; and a communication module configured to communicate content from the imaging device to the mobile cellular communication device when the solid member is disengaged from the mobile cellular communication device.

In another embodiment, a cover for a mobile cellular communication device includes an imaging device; and a communication module configured to wirelessly communicate content from the imaging device to the mobile cellular communication device; and a flexible member configured to support the cover at a support structure.

In yet another embodiment, a method of obtaining an image at a mobile communication device includes: removing a cover having an imaging device from the mobile communication device; placing the cover at a location remote from the mobile communication device; obtaining the image at the imaging device of the cover; and communicating the image from the cover to the mobile communication device using a communication link.

It should be understood that although illustrative implementations of one or more embodiments of the present disclosure are provided, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. An apparatus, comprising:
a solid member configured to engage with a mobile cellular communication device;
an imaging device disposed at the solid member configured to obtain a thermal image; and
a communication module configured to communicate content from the imaging device to the mobile cellular communication device when the solid member is disengaged from the mobile cellular communication device.

2. The apparatus of claim 1, further comprising at least one flexible member attached to the solid member and configured to be molded into a configuration to support the apparatus at a support structure.

3. The apparatus of claim 2, wherein the flexible member is configured to be molded into a configuration to perform at least one of: wrapping around the support structure; hanging from the support structure; and sitting on top of the support structure.

4. The apparatus of claim 1, wherein the solid member is configured to slide relative to the mobile cellular communication device to engage with the mobile cellular communication device.

5. The apparatus of claim 1, further comprising a communication plug configured to establish a wired communication link between the imaging device and the mobile cellular communication device, wherein engaging the solid member and the mobile cellular communication device results in the communication plug being inserted into a communication socket of the mobile cellular communication device to establish the wired communication link.

6. The apparatus of claim 5, wherein the communication plug is a Universal Serial Bus (USB) plug and the communication socket is a USB socket.

7. The apparatus of claim 1, wherein the communication module is configured to communicate the content using one of: a wireless communication link and a Bluetooth™ communication link.

8. A cover for a mobile cellular communication device, comprising:
an imaging device; and
a communication module configured to wirelessly communicate content from the imaging device to the mobile cellular communication device; and
a flexible member configured to support the cover at a support structure.

9. The cover of claim 8, wherein the flexible member is configured to be molded into a configuration to perform at least one of: wrapping around the supporting structure; hanging from the support structure; and sitting on top of the support structure.

10. The cover of claim 8, further comprising a track system configured for sliding engagement of the cover relative to the mobile cellular communication device to attach the cover to the mobile cellular communication device.

11. The cover of claim 8 further comprising a communication plug, wherein the communication plug is coupled to a communication socket of the mobile cellular communication device by placing the cover in an engaged position with the mobile cellular communication device.

12. The cover of claim 8, wherein the communication plug is a Universal Serial Bus (USB) plug and the communication socket is a USB socket.

13. The cover of claim 8, wherein the communication module is configured to communicate the content using one of: a wireless communication link; and a Bluetooth™ communication link.

14. The cover of claim 8, wherein the imaging device is at least one of an optical camera and a thermal camera and the content is at least one of an optical image and a thermal image.

15. A method of obtaining an image at a mobile communication device, the method comprising:
removing a cover having an imaging device from the mobile communication device;
placing the cover at a location remote from the mobile communication device;
obtaining the image at the imaging device of the cover; and
communicating the image from the cover to the mobile communication device using a communication link.

16. The method of claim 15, further comprising molding a flexible member of the cover into a configuration for supporting the cover at a support structure.

17. The method of claim 16, wherein supporting the cover at the support structure further comprises at least one of: wrapping the cover around the support structure; hanging the cover from the support structure; and supporting the cover on top of the support structure.

18. The method of claim 15, further comprising sliding the cover relative to the mobile cellular communication device to remove the cover from the mobile cellular communication device.

19. The method of claim 15, wherein the obtaining the image at the imaging device further comprising at least one of obtaining an optical image at an optical camera and obtaining a thermal image at a thermal camera.

20. The method of claim 15, further comprising communicating the image from the cover at the remote location to the mobile communication device using one of: a wireless communication link; a Bluetooth™ communication link; and a wired Universal Serial Bus (USB) connection.
